(19) United States
(12) Patent Application Publication
(10) Pub. No.: US 2006/0244919 A1
(43) Pub. Date: Nov. 2, 2006

(54) OPTICAL PROJECTING DEVICE AND POLARIZING LIGHT SOURCE MODULE THEREOF

(76) Inventor: Fu-Ming Chuang, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,534

(22) Filed: Apr. 4, 2006

(30) Foreign Application Priority Data
Apr. 28, 2005 (TW) 94113632

(51) Int. Cl. G03B 21/14

(52) U.S. Cl. 353/20

(57) ABSTRACT

An optical projection device and polarizing light source module are provided. The polarizing light source module includes a light source, a reflector and an optical sheet with a polarization splitting portion and a polarization conversion reflection portion. The light source provides an un-polarized light. The reflector with a reflection curved surface covers the light source with the optical sheet. A first polarized light passes through the polarization splitting portion and a second polarized light is reflected by that and passes to the reflection curved surface, then the second polarized light is reflected by the reflection curved and passes to the polarization conversion reflection portion. The second polarized light is converted to the first polarized light by the polarization conversion reflection portion, and the first polarized light reflected by the polarization conversion reflection portion is reflected by the reflection curved surface and penetrates through the polarization splitting portion.

### CROSS-REFERENCE TO RELATED APPLICATION

This application claims the priority benefit of Taiwan application serial no. 94113632, filed on Apr. 28, 2005. All disclosure of the Taiwan application is incorporated herein by reference.

### BACKGROUND OF THE INVENTION

1. Field of Invention

The present invention relates to a light source module. More particularly, the present invention relates to a polarizing light source module and an optical projection device using the polarizing light source module.

2. Description of Related Art

Please refer to FIG. 1, a conventional optical projection device 100 includes an illumination system 110, a light valve 120 and a projection lens 130. The illumination system 110 is used to provide a light beam 112, and the light valve 120 and the projection lens 130 are configured in a passing path of the light beam 112. The light valve 120 is disposed between the illumination system 110 and the projection lens 130. After the light beam 112 is passed from the illumination system 110 to the light valve 120, the light valve 120 converts the light beam 112 to an image and projects the image onto a screen 150 through the projection lens 130.

In the projection device 100 using a liquid crystal panel or silicon crystal panel as the light valve 120. The liquid crystal panel or silicon crystal panel only permits a linear polarization light to be entered. The light beam 112 is linearly polarized before it enters into the light valve 120. Moreover, in order to improve a light utilization, a polarization conversion device 140 is usually configured in the illumination system 110 so that the light beam 112 can be completely transformed into a desired polarization light. In addition to the polarization conversion device 140 as shown in FIG. 1, there is a variety of other types of polarization conversion devices, for example, U.S. Pat. No. 5,381,278, U.S. Pat. No. 6,816,206 and United States published application No. 20040257655 all disclose the art about polarization conversion devices.

The polarization conversion devices disclosed in FIG. 1 and in the aforementioned patents usually divide the natural light into s polarized light and p polarized light by polarized beam splitter (PBS) 142, and convert the polarizing light that can not pass through the PBS into the polarizing light that can pass through the PBS by a phase retarder 144. Wherein, as the conventional PBS cubic has large volume and large weight, the conventional polarization conversion devices generally use PBS sheet to shorten the overall volume of the optical projection device. However, the problem of the high fabrication cost and low light utilization of the PBS sheet has not been resolved yet.

Moreover, in the conventional optical projection device, after the light beam is emitted from the polarization conversion device, the etendue increases. For example, in the U.S. Pat. No. 6,81 6,206, the illumination area of the light beam emitted from the polarization conversion device is twice as large of that emitted directly from the light source so that the etendue is doubled, which results in overmuch loss of light energy.

### SUMMARY OF THE INVENTION

Accordingly, the present invention is directed to provide a polarizing light source module with simple assembly and low fabricating cost, and the etendue can be reduced.

Another object of the present invention is to provide an optical projection device, which directly provides a polarizing light using the aforementioned polarizing light source module so that the optical sheet disposed between the light source module and the light valve can be simplified, and further the overall volume and the fabricating cost can be reduced.

The present invention provides a polarizing light source module, comprising a light source, a reflector and an optical sheet with a polarization splitting portion and a polarization conversion reflection portion. Wherein, the light source is used for providing an un-polarized light. The reflector with a reflection curved surface covers the light source with the optical sheet. A first polarized light is passed through the polarization splitting portion and a second polarized light is reflected by that through the reflection curved surface to the polarization conversion reflection portion. The second polarized light is converted to the first polarized light by the polarization conversion reflection portion, and the first polarized light reflected by the polarization conversion reflection portion is reflected by the reflector and passes through the polarization splitting portion.

The present invention provides an optical projection device, comprising the aforementioned polarizing light source module, an imaging system and a light valve. Wherein the imaging system and the light valve are both disposed in the passing path of the second polarized light, and the light valve is configured between the polarizing light source module and the imaging system.

The light source module of the present invention is assembled by low cost components to directly provide polarized light. When the light source module is applied in any optical devices that need polarized light, not only the components of the optical devices can be simplified, but also the light utilization in the optical devices can be improved.

In order to the make the aforementioned and other objects, features and advantages of the present invention comprehensible, a preferred embodiment accompanied with figures is described in detail below.

### BRIEF DESCRIPTION OF THE DRAWINGS

FIG. 1 is a schematic structure diagram of a conventional optical projection device.

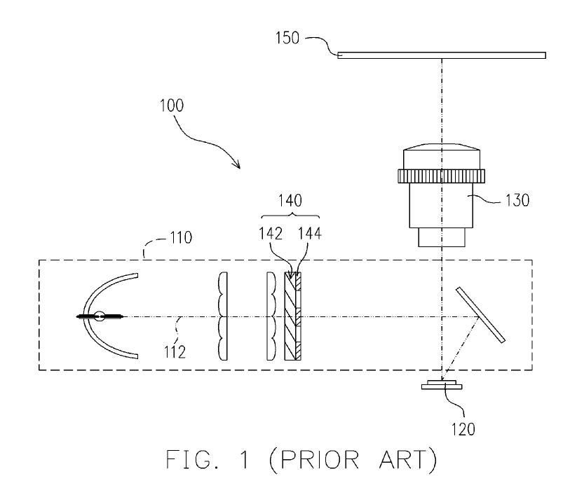

FIG. 2A is a schematic side view diagram of the polarizing light source module according to one preferred embodiment of the present invention.

FIG. 2B is a schematic front view diagram of the optical sheet in FIG. 2A.

FIG. 3 and FIG. 4 are the different schematic structure diagrams of the optical projection devices according to different embodiments of the present invention, respectively.

### DESCRIPTION OF EMBODIMENTS

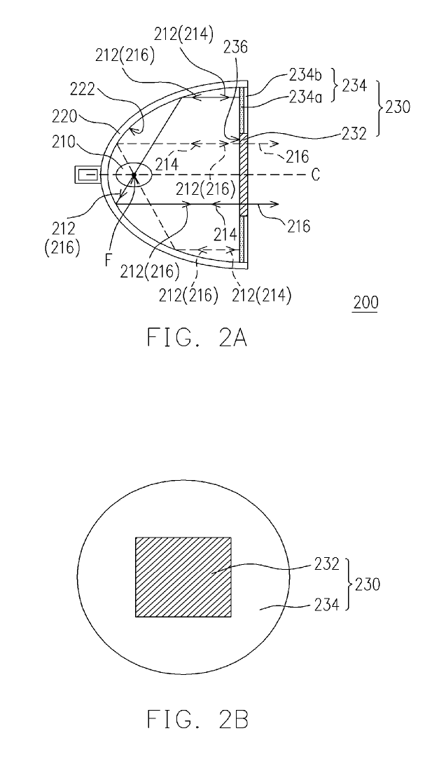

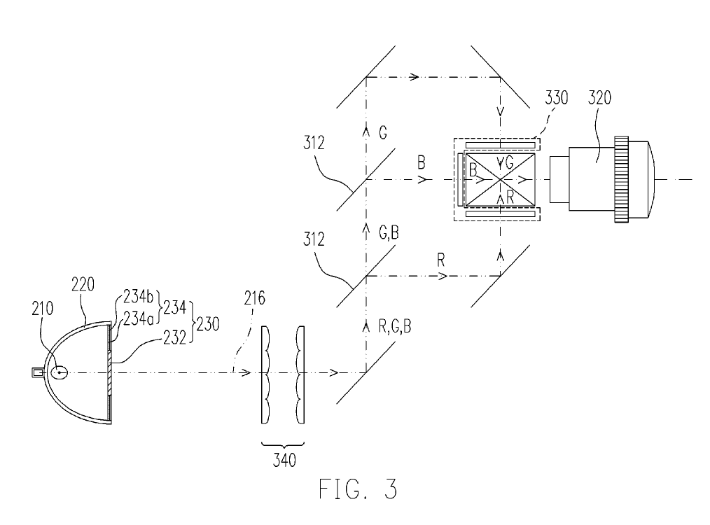

FIG. 2A is a schematic side view diagram of the polarizing light source module according to one preferred embodiment of the present invention. FIG. 2B is a schematic front view diagram of the optical sheet in FIG. 2A. Please refer to FIG. 2A, the polarizing light source module 200 comprises a light source 210, a reflector 220 and an optical sheet 230 with a polarization splitting portion 232 and a polarization conversion reflection portion 234. Wherein, both the reflector 220 and the optical sheet 230 have the property of reflecting light. The reflector 220 covers the reflection surface 236 of the optical sheet 230 so that the reflective curved surface 222 of the reflector 220 is opposite to the reflective surface 236 of the optical sheet 230.

As described above, the light source 210 disposed between the reflector 220 and the optical sheet 230 is used to provide an un-polarized light 212. In the present invention, the light source 210 may be a mercury lamp, a light emitting diode (LED), a metal halide lamp, a haloid lamp or a high intensity discharge lamp (HID lamp), etc. While the un-polarized light 212 is emitted from the light source 210, it is reflected by the reflective curved surface 222 of the reflector 220 and passed to the polarization splitting portion 232 or the polarization conversion reflection portion 234 of the optical sheet 230. More particularly, the reflective curved surface 222 of this embodiment is, for example, parabolic; and the light source 210 is, for example, located at the focus F of the parabolic reflective curved surface 222. Therefore, the passing path of the un-polarized light 212 emitted from the light source 210 is parallel to the optical axis C of the reflector 220 after being reflected by the reflective curved surface 222.

Please refer to FIG. 2A and FIG. 2B, it should be noted that the optical sheet 230, for example, comprises a reflective type polarizer and a reflective type phase retarder. That is, the polarization splitting portion 232 of the optical sheet 230 includes the reflective type polarizer, and the polarization conversion reflection portion 234 includes the reflective type phase retarder. Wherein, the reflective type polarizer is, for example, a rectangular shape; the reflective type phase retarder is, for example, an annular tray with a rectangular opening; and the rectangular reflective type polarizer is located in the rectangular opening; and the rectangular reflective type polarizer and the phase retarder constitute the disc-shaped optical sheet 230. In the embodiment, the area of the reflective type polarizer (the polarization splitting portion 232) is, for example, one half of the area of the optical sheet 230.

It should be noted that those skilled in the art can determine the shape, location and size of the reflective type polarizer, and determine the shape of the reflective type phase retarder according to the shape of the reflective type polarizer. Here, the examples are used to illustrate and should not limit the scope of the present invention.

Please continue to refer to FIG. 2A, it is known for those skilled in the art that the un-polarized light 212 is usually referred to the light beam with two polarizing directions. When the un-polarized light 212 is reflected by the reflective curved surface 222 and passed to the reflective type polarizer, the reflective type polarizer only permits the light beam polarized at one direction to pass through and reflects the light beam polarized at another direction. In the embodiment, the reflective type polarizer, for example, reflects the second polarized light 214 and let the first polarized light 216 pass through. Here, the first polarized light 216 can be p polarized light or s polarized light depending on the optical property of the reflective type polarizer. Moreover, when the first polarized light 216 is p polarized light, the second polarized light 214 is s polarized light. On the contrary, when the first polarized light 216 is s polarized light, the second polarized light 214 is p polarized light.

In addition, the reflective phase retarder, for example, comprises a phase retarder 234a and a reflective device 234b. The reflective device 234b is, for example, a reflective mirror used to reflect the light beam passing through the phase retarder 234a so as to pass through that the phase retarder 234a again. Moreover, there is a 90° phase difference between the reflecting light emitted from the reflective phase retarder and the incident light. Therefore, the phase retarder 234a, for example, is composed of n/4 one nth wave plates. For example, in the present invention, the phase retarder 234a is one piece quarter wave plate.

It should be noted that the above description does not limit the components of the reflective phase retarder of the present invention. In other embodiments, a metal surface coated with a layer of optical sheet with phase retarding function can also serve as the reflective phase retarder of the present invention.

In order to make the optical circuit design of the polarizing light source module of the present invention more comprehensible to those skilled in the art, the polarizing light source module as shown in FIG. 2A is described as example below.

Please again refer to FIG. 2A, as the reflective curved surface 222 of the reflector 220 of the present invention is parabolic, the passing path of all the light beam passing through the focus and reflecting by the reflective curved surface 222 is parallel to the optical axis C of the reflector 220. On the contrary, the light beam paralleling to the optical axis C of the reflector 220 passed to the reflective curved surface 222 will pass through the focus F of the reflective curved surface 222 after being reflected. Moreover, the light source 210 is located at the focus F, therefore all the light beams emitting from the light source 210 are parallel to the optical axis C after being reflected by the reflective curved surface 222.

As above, when the un-polarized light 212 from the light source 210 is reflected by the reflection curved surface 222 to the polarization splitting portion 232 of the optical sheet 230, the polarization splitting portion 232 will reflect the second polarized light 214 and emit the first polarized light 216 out of the polarizing light source module 200. Meanwhile, the second polarized light 214 is reflected through the reflective curved surface 222 to the polarization conversion reflection portion 234, and the second polarized light 214 is reflected through the polarization conversion reflection portion 234 and converted to the first polarized light 216. Further, the first polarized light 216 passes to the polarization splitting portion 232 along the reverse path of the second polarized light 214 and emitting out of the polarizing light source module 200.

In another aspect, when the un-polarized light 212 from the light source 210 is reflected through the reflective curved surface 222 to the polarization conversion reflection portion 234 of the optical sheet 230, the light beam polarized along s direction will be transformed to p polarized light beam by the polarization conversion reflection portion 234, and the light beam polarized along p direction will be transformed to s polarized light beam. Therefore, the light beam reflected from the polarization conversion reflection portion 234 is still un-polarized light 212. After that, the un-polarized light 212 is reflected by the reflective curved surface 222 and passes through the focus F, and again is reflected by the reflective curved surface 222 to the polarization splitting portion 232. At this time, the second polarized light 214 is reflected by the polarization splitting portion 232 and the first polarized light 216 is emitting out of the polarizing light source module 200. The passing path of the second polarized light 214 is the same as the above description and is omitted here.

As above, the polarized light from the polarizing light source of the present invention is emitted out by the polarization splitting portion 232, that is, the emitting cross section area of the polarizing light source module in the present invention is much smaller than that of the conventional light source module. As the etendue of the polarizing light source module is proportional to the light cross section area, the present invention has less etendue compared with that of the prior art. Thus, light energy can be emitted more intensively. In addition, since the polarizing light source module is applied to the optical projection device, not only the components are simplified, but also the light utilization and the light brightness of the optical projection device are further improved.

When the light source module 200 emits the first polarized light 216 in parallel, a condenser lens (not shown) can be configured outside of the optical sheet 230, so that the parallel first polarized light 216 can be become to the focused first polarized light.

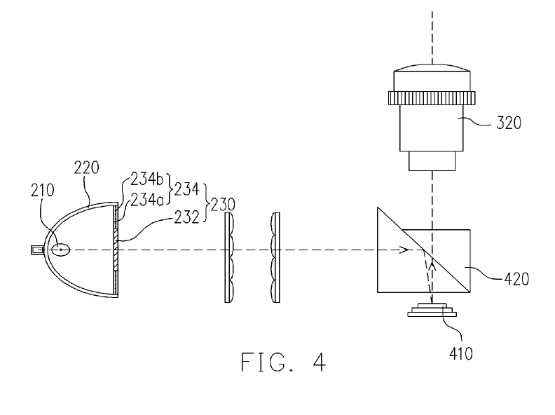

The following will illustrate the optical projection device using the aforementioned polarizing light source module. FIG. 3 is a schematic structure diagram of the optical projection device according to one embodiment of the present invention. Please refer to FIG. 3, the optical projection device 300 mainly comprises a polarizing light source module, an imaging system 320 and a light valve 330. Wherein, the polarizing light source module is, for example, the same as the polarizing light source module 200 (as shown in FIG. 2A) in the aforementioned embodiment; and the light valve 330 and the imaging system 320 are configured sequentially in the passing path of the first polarized light 216 emitted from the polarizing light source module 200. The light valve 330 can be, for example, a three-piece light valve. In addition, in one preferred embodiment, an integrator 340, such as a lens array, is configured between the polarizing light source module 310 and the light valve 330 so that the light intensity of the first polarized light 216 can be distributed uniformly, thus the loss of the luminous flux can be reduced.

As above, when the first polarized light 216 is emitted from the polarizing light source module 200, it is divided into trichromatic lights R, G, B by each spectroscope 312. After these colors are passed to the light valve 330, the first polarized light 216 is transformed into an image by the light valve 330 and passed to the imaging system 320. Then, the image is projected onto the screen (not shown) by the imaging system 320. It should be noted that although the light valve 330 as shown in FIG. 3 is a three transmissive light valve, it can also be a reflective light valve (not shown) in other embodiments. For example, the transmissive light valve is, for example, a liquid crystal panel, and the reflective light valve is, for example, a reflective crystal on silicon (LCOS) panel.

It is remarkable that although the light valves 330 in FIG. 3 is three-piece type, however the present invention is not limited to it. It is to be understood for those skilled in the art that the optical projection device can also transform the first polarized light 216 provided by the polarizing light source module into an image by a single-piece reflective light valve 410 with TIR prism 420 (as shown in FIG. 4), or even by a double-piece light valve (not shown).

In addition to the devices in the aforementioned description and figures, the optical projection device of the present invention also comprises the known devices in other optical projection devices. Those skilled in the art can understand the details, so the description is omitted.

Please again refer to FIG. 3, as the optical projection device 300 provides the first polarized light 216 directly by the polarizing light source module 310, no optical sheet is needed between the polarizing light source module 310 and the light valve 330 to polarize the light beam. That is, the optical projection device 300 of the present invention does not need the large and heavy PBS cubic or high cost and hard-made PBS sheet. Therefore, compared with the known optical projection devices, the assembly components are simpler and the fabricating cost is lower.

Moreover, in the optical projection device 300 of the present invention, as the first polarized light 216 provided by the polarizing light source module 310 is emitted through the polarization splitting portion 232 of the optical sheet 230, the etendue of the first polarized light 216 emitted from the polarizing light source module 310 can be reduced as long as the polarization splitting portion 232 has appropriate area. The following will illustrate the details according to the experiment data in the embodiment of the present invention.

TABLE 1

| | | | etendue | etendue |
|---|---|---|---|---|
| light valve | light valve | F/# of | (mm²- | (mm²- |
| area (inch, | area (inch, | Projection | steradian; | steradian; |
| 4:3) | 16:9) | lens | 4:3) | 16:9) |
| 0.55 | 0.55 | 2 | 18.39 | 16.36 |
| 0.55 | 0.55 | 2.4 | 12.77 | 11.36 |
| 0.55 | 0.55 | 2.5 | 11.77 | 10.47 |
| 0.55 | 0.55 | 2.8 | 9.38 | 8.35 |
| 0.72 | 0.7 | 2.5 | 20.17 | 16.96 |
| 0.72 | 0.6483 | 2.8 | 16.08 | 11.60 |
| 0.443 | 0.443 | 2.4 | 8.29 | 7.37 |

TABLE 2

| diameter of | | | |
|---|---|---|---|
| the circle | | | |
| emitting area | Arc gap of light | Focus of | etendue (mm²- |
| (mm) | source (mm) | reflector (mm) | steradian) |
| 95 | 1 | 7.5 | 11.52 |
| 95 | 1.3 | 7.5 | 19.47 |
| 98.81 | 1.3 | 10.2 | 27.01 |
| 95 | 1.3 | 7.5 | 20.32 |
| 98.81 | 1.3 | 10.2 | 20.32 |
| 98.81 | 1 | 10.2 | 15.98 |

Table 1 is the size specification and the etendue of the light valve in the optical projection device, and Table 2 is the size specification and the etendue of the light source module in the optical projection device. Please refer to Table 1, for example, a 0.55 inch light valve uses the projection lens with F/# of 2.4 and the aspect ratio is 16:9, then the etendue is 11.36.

Please refer to Table 2, in the aforementioned conditions, if the diameter of the circle emitting area of the light source module is 98.81 mm, the arc gap is 1 mm, and the focus of the reflector is 10.2 mm, the etendue would be 15.98. If using the conventional polarization conversion device, the etendue would increase to about 32, much larger than the etendue of the light valve, which may result in the loss of light energy.

However, for an identical specific light source module, if the polarizing light source module of the present invention is applied and the area of the polarization splitting portion is designed to one half of the overall area of the optical sheet, that is, the emitting area of the polarizing light source module of the present invention is smaller than the conventional emitting area. (For example, the emitting area of the polarizing light source module of the present invention is one quarter of that in U.S. Pat. No. 6,816,206.) In such, as the etendue is proportional to the emitting area, the etendue of the present invention can be reduced to about 8.0, which is smaller than that of the light valve so as to improve the light energy collection.

In summary, as the polarizing light source module of the present invention uses the compact, light and easy fabricating optical sheet to perform polarization conversion, compared with the conventional light source module, except that the polarizing light source module of the present invention can provide polarized light directly, it also has advantages such as light, space saving, easy assembly and low fabricating cost. In addition, as the polarizing light source module of the present invention concentrates the light beams to one certain region to emit, the emitting light has small etendue. That is, the polarizing light source module of the present invention can reduce the energy loss of the emitting light.

It is apparent that if the polarizing light source module of the present invention is applied in some optical devices that need polarized light source, the efficiency of the optical devices can be improved. The optical projection device of the present invention emits polarized light to light valve directly using the polarizing light source module of the present invention. That is, the optical projection device of the present invention does not need PBS to perform the polarizing conversion so that the optical projection device of the present invention not only has smaller volume, but also reduces fabricating cost. Moreover, the polarizing light source module can concentrate the energy of the emitting light, which greatly improves the light utilization of optical projection device of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A polarizing light source module, suitable to provide a first polarized light, comprising:
a reflector with a reflection curved surface;
a light source, used for providing an un-polarized light including a first polarized light and a second polarized light; and
an optical sheet, with the reflector covering the light source, the optical sheet having a polarization splitting portion and a polarization conversion reflection portion, wherein the first polarized light is passed through the polarization splitting portion and the second polarized light is reflected by the reflection curved surface and passes to the polarization conversion reflection portion, and the second polarized light is converted to the first polarized light by the polarization conversion reflection portion, then the first polarized light reflected by the polarization conversion reflection portion is reflected by the reflection curved surface and penetrates through the polarization splitting portion.

2. The polarizing light source module as claimed in claim 1, wherein the polarization conversion reflection portion is suitable to convert the first polarized light into the second polarized light.

3. The polarizing light source module as claimed in claim 1, wherein the polarization splitting portion comprises a reflective type polarizer, and the polarization conversion reflection portion comprises:
a phase retarder; and
a reflective device, suitable to reflect a light beam passing through the phase retarder, and then the light beam passing through the phase retarder again.

4. The polarizing light source module as claimed in claim 3, wherein the phase retarder comprises a quarter wave plate, and the reflective device comprises a reflection mirror.

5. The polarizing light source module as claimed in claim 1, wherein the polarization splitting portion is a rectangular shape, and the polarization conversion reflection portion is an annular tray with a rectangular opening, and the polarization splitting portion is located within the rectangular opening.

6. The polarizing light source module as claimed in claim 1, wherein the reflective curved surface is a parabolic curved surface, and the light source is at a focus of the parabolic curved surface.

7. The polarizing light source module as claimed in claim 6 further comprises a condenser lens configured outside of the optical sheet.

8. The polarizing light source module as claimed in claim 1, wherein the first polarized light is p polarized light while the second polarized light is s polarized light.

9. The polarizing light source module as claimed in claim 1, wherein the first polarized light is s polarized light while the second polarized light is p polarized light.

10. An optical projection device, comprising:
a polarizing light source module including:
a reflector with a reflection curved surface;
a light source, used for providing an un-polarized light including a first polarized light and a second polarized light; and
an optical sheet, with the reflector covering the light source, having a polarization splitting portion and a polarization conversion reflection portion, wherein the first polarized light is passed through the polarization splitting portion and the second polarized light is reflected by the reflection curved surface and passes to the polarization conversion reflection portion, and the second polarized light is converted to the first polarized light by the polarization conversion reflection portion, then the first polarized light reflected by the polarization conversion reflection portion is reflected by the reflection curved surface and penetrates through the polarization splitting portion;
an imaging system, disposed in the passing path of the second polarized light; and
a light valve, configured between the polarizing light source module and the imaging system, and disposed in the passing path of the second polarized light.

11. The optical projection device as claimed in claim 10, wherein the polarization conversion reflection portion is suitable to convert the first polarized light into the second polarized light.

12. The optical projection device as claimed in claim 10, wherein the polarization splitting portion comprises a reflective type polarizer, and the polarization conversion reflection portion comprises
a phase retarder; and
a reflective device, suitable to reflect the light beam passing through the phase retarder and then the light beam passing through the phase retarder again.

13. The optical projection device as claimed in claim 12, wherein the phase retarder comprises a quarter wave plate, and the reflective device comprises a reflection mirror.

14. The optical projection device as claimed in claim 10, wherein the polarization splitting portion is a rectangular shape, and the polarization conversion reflection portion is an annular tray with a rectangular opening, and the polarization splitting portion is located within the rectangular opening.

15. The optical projection device as claimed in claim 10, wherein the reflective curved surface is a parabolic curved surface, and the light source is at a focus of the parabolic curved surface.

16. The optical projection device as claimed in claim 15 further comprises a condenser lens configured outside of the optical sheet.

17. The optical projection device as claimed in claim 10, wherein the first polarized light is p polarized light while the second polarized light is s polarized light.

18. The optical projection device as claimed in claim 10, wherein the first polarized light is s polarized light while the second polarized light is p polarized light.

19. The optical projection device as claimed in claim 10, wherein the light valve comprises at least one transmissive light valve.

20. The optical projection device as claimed in claim 10, wherein the light valve comprises at least one reflective light valve.
